(19) United States
(12) Patent Application Publication
(10) Pub. No.: US 2021/0103181 A1
(43) Pub. Date: Apr. 8, 2021

(54) LIQUID CRYSTAL DEVICE

(71) Applicant: Innolux Corporation, Miao-Li County (TW)

(72) Inventors: Chen-Lin Yeh, Miao-Li County (TW); Chin-Lung Ting, Miao-Li County (TW)

(73) Assignee: Innolux Corporation, Miao-Li County (TW)

(21) Appl. No.: 17/012,071

(22) Filed: Sep. 4, 2020

Related U.S. Application Data
(60) Provisional application No. 62/909,809, filed on Oct. 3, 2019.

(30) Foreign Application Priority Data
Jun. 29, 2020 (CN) 202010603303.8

(51) Int. Cl. G02F 1/1333; G02F 1/1339; H05B 1/02

(52) U.S. Cl. CPC G02F 1/133382; H05B 3/20; H05B 1/0294; G02F 1/1339

(57) ABSTRACT

A liquid crystal device, including two substrates disposed opposite to each other, a liquid crystal layer disposed between the two substrates, and multiple heating units disposed on at least one of the two substrates, is provided. Each heating unit includes a heater and a switch element coupled to the heater. The liquid crystal device according to the embodiments of the disclosure may operate in different ambient temperatures.

### CROSS-REFERENCE TO RELATED APPLICATION

This application claims the priority benefit of U.S. provisional application Ser. No. 62/909,809, filed on Oct. 3, 2019, and China application serial no. 202010603303.8, filed on Jun. 29, 2020. The entirety of each of the above-mentioned patent applications is hereby incorporated by reference herein and made a part of this specification.

### BACKGROUND

### Technical Field

This disclosure relates to a liquid crystal device.

### Description of Related Art

With the continuous expansion of liquid crystal device applications, liquid crystal devices will operate in different environments and will also face different issues. Therefore, there is a need to continuously update and adjust the research and development of liquid crystal devices.

### SUMMARY

This disclosure provides a liquid crystal device that can operate in different ambient temperatures.

According to an embodiment of the disclosure, the liquid crystal device includes two substrates disposed opposite to each other, a liquid crystal layer disposed between the two substrates, and multiple heating units disposed on at least one of the two substrates. Each heating unit includes a heater and a switch element coupled to the heater.

To make the aforementioned more comprehensible, several embodiments accompanied by drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and together with the description, serve to explain the principle of the disclosure.

FIG. 1 is a cross-sectional schematic view of a liquid crystal device according to an embodiment of the disclosure.

FIG. 2 is a top schematic view of a liquid crystal device according to an embodiment of the disclosure.

FIG. 3 is a circuit schematic view of a heating unit according to an embodiment of the disclosure.

FIG. 4 is a cross-sectional schematic view of a working unit according to an embodiment of the disclosure.

### DESCRIPTION OF THE EMBODIMENTS

Reference will now be made in detail to the exemplary embodiments of the disclosure, examples of which are illustrated in the drawings. Whenever possible, the same reference numerals are used in the drawings and descriptions to represent the same or similar parts.

When a structure (layer, component, or substrate) described in the disclosure is located on/above another structure (layer, component, or substrate), it may indicate that the two structures are adjacent and directly connected, or it may also indicate that the two structures are adjacent and indirectly connected. Being indirectly connected indicates that there is at least one intermediary structure (intermediary layer, intermediary component, intermediary substrate, or intermediary spacing) between the two structures, in which the lower surface of one structure is adjacent or directly connected to the upper surface of the intermediary structure, and the upper surface of the other structure is adjacent or directly connected to the lower surface of the intermediary structure, and the intermediary structure may be composed of a single-layer or a multi-layer physical structure or non-physical structure, without any limitation. In the disclosure, when a structure is disposed “on” another structure, it may indicate that the structure is “directly” on the other structure, or that the structure is “indirectly” on the other structure, that is, at least one structure is sandwiched between the structure and the other structure.

The terms “electrically connected” or “coupled” described in the disclosure may indicate being directly connected or indirectly connected. In the case of being directly connected, the end points of elements on two circuits are directly connected or connected to each other by a conductor wire segment. In the case of being indirectly connected, there is an element such as a switch, a diode, a capacitor, an inductor, a resistor, other suitable elements, or a combination of the above elements between the end points of the elements on the two circuits, but not limited thereto.

In the disclosure, the thickness, length, and width may be measured by an optical microscope, while the thickness may be measured from a cross-sectional image of an electron microscope, but not limited thereto. In addition, any two values or directions for comparison may have certain differences. If a first value is equal to a second value, it implies that there may be a difference of about 10%, 5%, or 3% between the first value and the second value.

It should be noted that in the following embodiments, the features in several different embodiments may be replaced, recombined, and mixed to form other embodiments without departing from the spirit of the disclosure. As long as the features between the embodiments do not violate the spirit of the disclosure or are not in conflict with each other, they may be mixed and used arbitrarily.

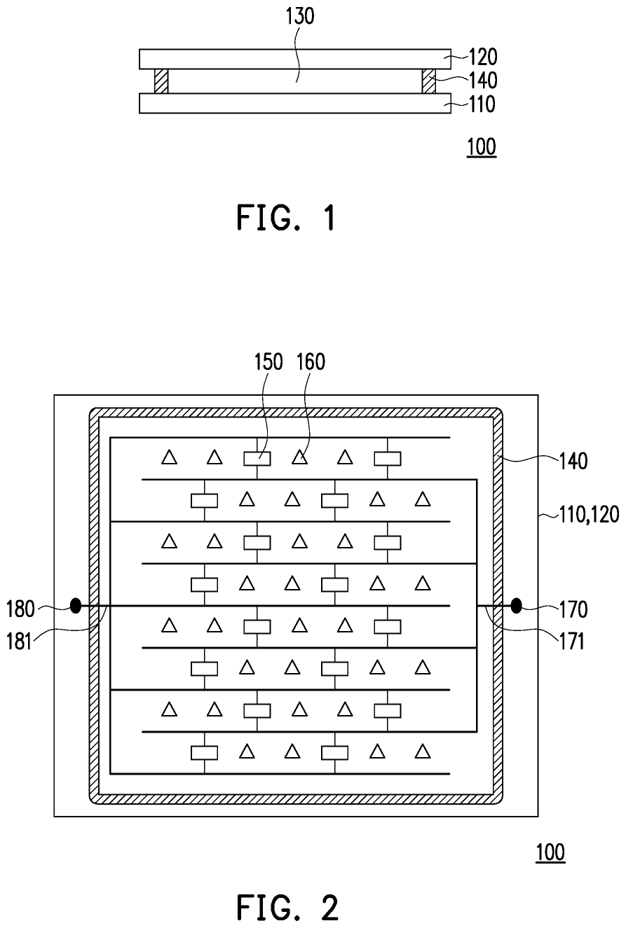

FIG. 1 is a cross-sectional schematic view of a liquid crystal device according to an embodiment of the disclosure. In FIG. 1, a liquid crystal device 100 includes a substrate 110 and a substrate 120 disposed opposite to each other, a liquid crystal layer 130 disposed between the substrate 110 and the substrate 120, and a sealant 140 disposed between the substrate 110 and the substrate 120 and surrounding the liquid crystal layer 130. The substrate 110 and the substrate 120 may each be a hard substrate or a flexible substrate. The material of the hard substrate may include glass, quartz, other suitable materials, or a combination of the above materials, but the disclosure is not limited thereto. The flexible substrate may include a single-layer structure of one of polyimide (PI), polyethylene terephthalate (PET), or other applicable materials, or a stack or mixture of at least two of the above materials, but the disclosure is not limited thereto. The material of the sealant 140 includes, for example, a resin material, and the sealant 140 has a sealing characteristic, so as to seal the liquid crystal layer 130 between the substrate 110 and the substrate 120. In some embodiments, the sealant 140 has a ring pattern, and liquid crystal may be filled in the space surrounded by the substrate 110, the substrate 120, and the sealant 140 to constitute the liquid crystal layer 130.

In general, the liquid crystal molecules in the liquid crystal layer 130 may exhibit favorable characteristics, such as optical characteristic, electromagnetic wave modulation characteristic, etc., in an environment within a temperature range to realize the function of the liquid crystal device 100. The temperature range may be regarded as a working temperature range of the liquid crystal layer 130. In some embodiments, the working temperature range of the liquid crystal layer 130 may be, for example, between 10 degrees Celsius and 70 degrees Celsius, such as the room temperature. If the ambient temperature of an environment where the liquid crystal device 100 is located is lower than the working temperature range of the liquid crystal layer 130, the operation quality of the liquid crystal device 100 may be reduced because the liquid crystal layer 130 cannot exhibit the expected characteristics. In some embodiments, when the ambient temperature of the liquid crystal device 100 installed outdoors or in a vehicle is lower than the working temperature range of the liquid crystal layer 130, the liquid crystal device 100 may not work normally. By disposing heating units in the liquid crystal device 100, the temperature of the liquid crystal layer 130 may be heated to be within the working temperature range, so that the liquid crystal device 100 may operate in a low temperature environment (below the working temperature range of the liquid crystal layer 130), and is less affected by the ambient temperature.

FIG. 2 is a top schematic view of a liquid crystal device according to an embodiment of the disclosure. FIG. 2 may be regarded as one of the implementation manner of the liquid crystal device 100 of FIG. 1, but the disclosure is not limited thereto. The geometrical patterns in FIG. 2 only schematically represent different components in the liquid crystal device 100, rather than presenting the specific structure of each component. In FIG. 2, the liquid crystal device 100 includes multiple heating units 150 and multiple working units 160. Specifically, with reference to FIGS. 1 and 2 concurrently, the heating units 150 and the working units 160 may be located between the substrate 110 and the substrate 120 of FIG. 1 and disposed on at least one of the substrate 110 and the substrate 120. The heating units 150 are configured to heat the liquid crystal layer 130 in the liquid crystal device 100, and the working units 160 are configured to drive the liquid crystal layer 130 to realize the function of the liquid crystal device 100. In some embodiments, the heating units 150 may be disposed on a surface (not shown) of the substrate 110 close to the liquid crystal layer 130 to raise the temperature of the liquid crystal layer 130 to be within the working temperature range. In some embodiments, the heating units 150 may be disposed on a surface (not shown) of the substrate 110 away from the liquid crystal layer 130 to raise the temperature of the liquid crystal layer 130 to be within the working temperature range, but the disclosure is not limited thereto.

In some embodiments, the heating units 150 may be disposed on a surface (not shown) of the substrate 110 and the substrate 120. For example, the heating units 150 may be disposed on a surface of the substrate 110 and the substrate 120 close to the liquid crystal layer 130 concurrently; or the heating units 150 may be disposed on a surface of the substrate 110 and the substrate 120 away from the liquid crystal layer 130 concurrently; or some of the heating units 150 are disposed on a surface of one of the substrate 110 and the substrate 120 close to the liquid crystal layer 130 while the other heating units 150 are disposed on a surface of the other of the substrate 110 and the substrate 120 away from the liquid crystal layer 130, but the disclosure is not limited thereto. In some embodiments, the number of the heating units 150 and the number of the working units 160 may be different, but may also be the same. In addition, the liquid crystal device 100 includes a voltage input pad 170, a voltage input line 171, a voltage output pad 180, and a voltage output line 181. The voltage input line 171 is coupled to the heating units 150 and the voltage input pad 170. The voltage output line 181 is coupled to the heating units 150 and the voltage output pad 180. In this way, the heating unit 150 may generate thermal energy when the voltage input pad 170 and the voltage output pad 180 have a voltage difference to heat the liquid crystal layer 130. In the embodiment, the heating units 150 are disposed between the voltage input pad 170 and the voltage output pad 180 and are two port type heating elements. However, in other embodiments, the heating units 150 may realize the heating function through other forms of circuit structure, and the disclosure is not limited thereto.

In the embodiment, the heating unit 150 may raise the temperature of the liquid crystal layer 130 to be within the working temperature range and the liquid crystal device 100 may work normally in different ambient temperatures. In other words, the liquid crystal device 100 may still work normally in a low temperature environment (below the working temperature range of the liquid crystal layer 130), and is less affected by the ambient temperatures. Therefore, the operation quality of the liquid crystal device 100 may be improved. In addition, each heating unit 150 may be disposed adjacent to at least one working unit 160. In some embodiments, the position of the heating unit 150 may be disposed according to the conditions, such as characteristics and application environment, of the liquid crystal device 100. For example, the multiple heating units 150 may be evenly disposed in the liquid crystal device 100 at equal spacing. Alternatively, the distribution of the heating units 150 may be more densely distributed in one region of the liquid crystal device 100 and more loosely distributed in another region. For example, the distribution of the heating units 150 may be more densely distributed in a working region of the liquid crystal device 100 and more loosely distributed in a peripheral region of the liquid crystal device 100, but the disclosure is not limited thereto.

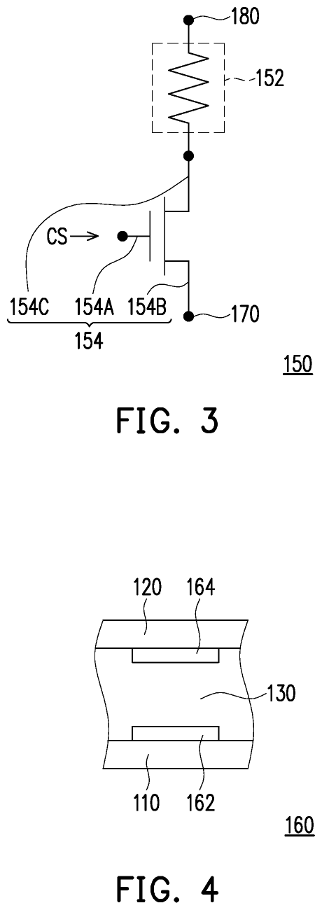

FIG. 3 is a circuit schematic view of a heating unit according to an embodiment of the disclosure. The circuit of FIG. 3 may be applied to FIG. 2 as an implementation manner of each heating unit 150, but is not limited thereto. In FIG. 3, the heating unit 150 includes a heater 152. The heater 152, for example, coupled to the voltage input pad 170 and the voltage output pad 180. In some embodiments, the voltage input pad 170 and the voltage output pad 180 may respectively provide different voltage values to form a voltage difference (V) at both ends of the heater 152, so as to generate a current (I) to flow through the heater 152. The heater 152 has a resistance value (R). Therefore, when the current (I) flows through the heater 152, a thermal energy (P) is generated. According to the definition of power and Ohm's law, the thermal energy (P) generated by the heater 152 may satisfy the following formula: P=V²/R=I²R, where the unit of P is watt (W), the unit of V is volt (V), and the unit of I is ampere (A). The liquid crystal device 100 may adjust the resistance value of the heater 152, the voltage value of the voltage input pad 170, and the voltage value of the voltage output pad 180 according to the above formula and the required heating performance. In some embodiments, the heater 152 may be a conductive component with impedance, such as an electric heating wire, an electric heating sheet, and an electric heating plate, but the disclosure is not limited thereto.

In addition, the heating unit 150 includes a switch element 154 coupled to the heater 152. Here, the switch element 154 may be, for example, a transistor element, but the disclosure is not limited thereto. If the switch element 154 is disposed on the surface of the substrate away from the liquid crystal layer 130 and the heater 152 is disposed on the surface of the substrate close to the liquid crystal layer 130, a through hole may be needed in the substrate and a conductive element may be disposed in the through hole, so that the switch element 154 is coupled to the heater 152 through the conductive element in the through hole, or the switch element 154 is coupled to the heater 152 through the conductive element disposed on a side surface of the substrate, but the disclosure is not limited thereto. The switch element 154 includes a first end 154A, a second end 154B, and a third end 154C. The first end 154A may receive a control signal CS, the second end 154B is coupled to the voltage input pad 170, and the heater 152 is coupled to the third end 154C and the voltage output pad 180. In this way, the switch element 154 may control whether the current generated by the voltage difference between the voltage input pad 170 and the voltage output pad 180 flow through the heater 152, so as to control the operation of the heating units 150. In some embodiments, when the heating units 150 are required to heat the liquid crystal layer 130, the control signal CS may be set to a signal that switches on the switch element 154. In this way, the current generated by the voltage difference between the voltage input pad 170 and the voltage output pad 180 may be inputted from the voltage input pad 170 to the heater 152 and then outputted from the voltage output pad 180, so that the heater 152 generates thermal energy to heat the liquid crystal layer 130 to be within the working temperature range. When the heating units 150 are not required to provide the heating function, the control signal CS may be set to a signal that switches off the switch element 154, then there will be no current flowing through the heater 152 and the heater 152 does not generate thermal energy.

In some embodiments, the control signal CS may be adjusted according to different parameters, so that the heating units 150 carry out the heating function in response to different conditions. For example, the liquid crystal device 100 may be operated in collocation with a thermal sensing device (not shown). The thermal sensing device, such as an infrared sensor, a temperature sensor, or other similar devices, may sense the temperature of the liquid crystal device 100. When the result sensed by the thermal sensing device shows that the temperature of the liquid crystal device 100 is lower than the working temperature range (for example, 10 degrees Celsius) of the liquid crystal layer 130, the thermal sensing device may provide the result to a control circuit (not shown), such as a driving circuit of the liquid crystal device 100, to enable the control circuit to output the control signal CS to switch on the switch element 154, so that the heating units 150 heat the liquid crystal layer 130 to be within the working temperature range. In some embodiments, if the result sensed by the thermal sensing device shows that the temperature of the liquid crystal device 100 is close to or has reached the highest value (for example, 70 degrees Celsius) of the working temperature range of the liquid crystal layer 130, the thermal sensing device may provide the result to the control circuit, to enable the control circuit to output the control signal CS to switch off the switch element 154 and stop the heating units 150 from continuously heating the liquid crystal layer 130. In other words, the liquid crystal device 100 may adjust the control signal CS to control the heating unit 150 to carry out heating or to stop heating in a specified time period, so as to achieve a time-partitioned heating performance. However, the disclosure is not limited thereto. In some embodiments, the liquid crystal device 100 may be operated in collocation with a thermostatic device (not shown) to heat the liquid crystal layer 130 to a predetermined temperature range within the working temperature range.

In some embodiments, the multiple heating units 150 in the liquid crystal device 100 may carry out heating at different time points or time intervals. For example, the liquid crystal device 100 may be operated in collocation with the thermal sensing device (not shown). When the result sensed by the thermal sensing device shows that the temperature of a partial region of the liquid crystal device 100 is lower than the working temperature range of the liquid crystal layer 130, the region is a low temperature region, and then the thermal sensing device may provide the result to the control circuit. The control circuit will adjust the control signal CS to switch on the switch element 154 corresponding to the low temperature region, so that the corresponding heating unit 150 heats the liquid crystal layer 130 in the low temperature region, while the heating units 150 in other regions do not heat the liquid crystal layer 130 outside of the low temperature region because they are not activated. In other words, the liquid crystal device 100 may control the heating units 150 at different positions to carry out heating or to stop heating by adjusting the control signal CS, so as to achieve a space-partitioned heating performance.

In some embodiments, the control circuit may adjust the control signal CS to allow the heating unit 150 to carry out heating at a specified frequency. For example, the control circuit may adjust the control signal CS to allow the heating unit 150 to carry out heating at a higher frequency or to carry out heating at a lower frequency during a specified time period. In other words, the liquid crystal device 100 may control the heating unit 150 to carry out heating at different frequencies by adjusting the control signal CS, so as to achieve a heating performance of different heating speeds.

FIG. 4 is a cross-sectional schematic view of a working unit according to an embodiment of the disclosure. The structure presented in FIG. 4 may be applied to the liquid crystal device 100 in FIGS. 1 and 2 as an implementation manner of the working unit 160, but the disclosure is not limited thereto. In FIG. 4, the working unit 160 is, for example, disposed in the liquid crystal device 100 and configured to drive the liquid crystal layer 130. In some embodiments, the working unit 160 may include an electrode 162 and an electrode 164, which are disposed between the substrate 110 and the substrate 120. The electrode 162 is disposed on the substrate 110 and the electrode 164 is disposed on the substrate 120, so that the liquid crystal layer 130 is located between the electrode 162 and the electrode 164, but the disclosure is not limited thereto. In other embodiments, the electrode 162 and the electrode 164 may be both disposed on the substrate 110 or both disposed on the substrate 120.

When the liquid crystal device 100 is working, the electrode 162 and the electrode 164 of the working unit 160 may generate an electric field to drive the liquid crystal layer 130. In some embodiments, the liquid crystal device 100 is, for example, a liquid crystal display device, and the working unit 160 is, for example, a pixel unit, then one of the electrode 162 and the electrode 164 is a pixel electrode, while the other is a common electrode. In addition, the electrode 162 and the electrode 164 may generate the electric field to control the inclined state of the liquid crystal molecules of the liquid crystal layer 130, so that changing the polarization of a light passing through the liquid crystal layer 130. In other embodiments, the liquid crystal device 100 is, for example, an electromagnetic wave adjustment device. For example, the electromagnetic wave adjustment device may include a liquid crystal antenna device. In this way, the working unit 160 is, for example, an antenna unit, and the electrode 162 and the electrode 164 are respectively located on the substrate 110 and the substrate 120, but the disclosure is not limited thereto. Although the electrode 162 and the electrode 164 in FIG. 4 are presented as being disposed opposite to each other, this is only to schematically describe a possible implementation manner of the working unit 160. In some embodiments, the electrode 162 and the electrode 164 may be disposed apart from each other according to the required function. For example, the electrode 162 and the electrode 164 may partially overlap or not overlap at all or may be disposed in other corresponding relationships. In addition, the disclosure does not specifically limit the design of the working unit 160. In some embodiments, the working unit 160 may include components other than the electrode 162 and the electrode 164.

Specifically, both the heating unit 150 of FIG. 3 and the working unit 160 of FIG. 4 are disposed in the liquid crystal device 100 shown in FIGS. 1 and 2. In some embodiments, a region of the working unit 160 and a region of the heating unit 150 may be disposed independent of each other without overlap. In some embodiments, a region of the working unit 160 and a region of the heating unit 150 may be disposed in different stack layers, so that the working unit 160 and the heating unit 150 may be overlapped. In this way, the operation of the working unit 160 is less affected by the disposition of the heating unit 150, so as to improve the operation quality of the liquid crystal device 100.

In summary, the liquid crystal device in the embodiments of the disclosure integrates the heating units to heat the liquid crystal device as required, so that the liquid crystal device is less affected by the environment and can work normally. In the embodiments of the disclosure, the heating units may be distributed in different regions of the entire liquid crystal device, and the different heating units may be operated at different times to heat the required region of the liquid crystal device at the required time.

Finally, it should be noted that the foregoing embodiments are only used to illustrate the technical solutions of the disclosure, and not intended to limit the disclosure. Although the disclosure has been described in detail with reference to the foregoing embodiments, persons skilled in the art should understand that modifications to the technical solutions described in the foregoing embodiments or equivalent replacements may be made to some or all of the technical features. However, the modifications or replacements do not cause the essence of the corresponding technical solutions to depart from the scope of the technical solutions according to the embodiments of the disclosure.

What is claimed is:

1. A liquid crystal device, comprising:
two substrates, disposed opposite to each other;
a liquid crystal layer, disposed between the two substrates; and
a plurality of heating units, disposed on at least one of the two substrates, wherein each of the heating units comprises:
a heater; and
a switch element, coupled to the heater.

2. The liquid crystal device according to claim 1, wherein each of the plurality of heating units is driven independently.

3. The liquid crystal device according to claim 1, comprising a voltage input pad and a voltage output pad, and the plurality of heating units coupled to the voltage input pad and the voltage output pad.

4. The liquid crystal device according to claim 3, wherein the heater is coupled to the voltage input pad and the voltage output pad.

5. The liquid crystal device according to claim 4, wherein the switch element comprises a first end, a second end, and a third end, the first end is configured to receive a control signal, the second end is coupled to the voltage input pad, and the heater is coupled to the third end and the voltage output pad.

6. The liquid crystal device according to claim 3, comprising a voltage input line and a voltage output line, and the voltage input line coupled to the plurality of heating units and the voltage input pad, and the voltage output line coupled to the plurality of heating units and the voltage output pad.

7. The liquid crystal device according to claim 1, comprising a plurality of working units, and each of the plurality of heating units being adjacent to at least one of the plurality of working units.

8. The liquid crystal device according to claim 7, wherein each of the plurality of working units comprises two electrodes respectively disposed on the two substrates, and the liquid crystal layer is sandwiched between the two electrodes.

9. The liquid crystal device according to claim 7, wherein a number of the plurality of heating units and a number of the plurality of working units are the same.

10. The liquid crystal device according to claim 7, wherein a number of the plurality of heating units and a number of the plurality of working units are different.

11. The liquid crystal device according to claim 7, wherein one of the plurality of heating units overlaps the at least one of plurality of the working units.

12. The liquid crystal device according to claim 1, wherein the liquid crystal device is a liquid crystal display device.

13. The liquid crystal device according to claim 1, wherein the liquid crystal device is an electromagnetic wave adjustment device.

14. The liquid crystal device according to claim 1, comprising a sealant disposed between the two substrates and surrounding the liquid crystal layer.

15. The liquid crystal device according to claim 1, wherein the plurality of heating units are disposed on a surface of one of the two substrates close to the liquid crystal layer.

16. The liquid crystal device according to claim 1, wherein the plurality of heating units are disposed on a surface of one of the two substrates away from the liquid crystal layer.

17. The liquid crystal device according to claim 1, wherein a distribution of the plurality of heating units is more densely distributed in a region of the liquid crystal device and more loosely distributed in another region.

18. The liquid crystal device according to claim 1, wherein the plurality of heating units are disposed at equal spacing.

19. The liquid crystal device according to claim 1, wherein the heater comprises an electric heating wire, an electric heating sheet, or an electric heating plate.

20. The liquid crystal device according to claim 1, wherein the switch element and the heater are disposed on two opposite surfaces of one of the two substrates.
